(19) United States
(12) Patent Application Publication
(10) Pub. No.: US 2017/0003415 A1
(43) Pub. Date: Jan. 5, 2017

(54) System And Method For Radiation Inspection On Moving Object

(71) Applicant: POWERSCAN COMPANY LIMITED, Beijing (CN)

(72) Inventors: Shaofeng Wang, Beijing (CN); Xiong Yan, Beijing (CN); Yanfeng Cao, Beijing (CN); Xiaowei Hu, Beijing (CN)

(73) Assignee: Powerscan Company Limited, Beijing (CN)

(21) Appl. No.: 15/125,727

(22) PCT Filed: Mar. 3, 2015
(86) PCT No.: PCT/CN2015/073551

§ 371 Date: Sep. 13, 2016

(30) Foreign Application Priority Data
Mar. 24, 2014 (CN) 201410111164.1

(51) Int. Cl. G01V 5/00; G01N 23/04

(52) U.S. Cl. CPC G01V 5/0066; G01N 23/04; G01N 2223/03

(57) ABSTRACT

A system and method for radiation inspection on a moving object. The system comprises a radiation source and a radiation detector. Rays emitted by the radiation source are limited in a scanning area. The scanning area is provided by a first boundary surface and a second boundary surface. The system also comprises: multiple detection units arranged along a detection channel in turn and used for triggering and sending a signal when detecting that the moving object arrives or leaves; and a control module used for receiving signals sent by the multiple detection units and controlling the radiation source according to the received signal. The first to third detection units among the multiple detection units are located at one side of the scanning area and near the first boundary surface. The fourth to sixth detection units among the multiple detection units are located at the other side of the scanning area and near the second boundary surface. The system and the method can implement radiation inspection on moving objects traveling in multiple directions.

### TECHNICAL FIELD

The present invention relates to a technical field of radiation scanning, and specifically to a system and a method for radiation inspection on a moving object.

### BACKGROUND OF THE INVENTION

Nowadays, utilizing high energy radiation for automatic scanning inspection on an object moving with high speed, such as a running vehicle, can accomplish a security check for smuggled, illegal and prohibited objects, without interrupting the passing of the vehicles with high speed and is an ideal means for performing a 100% vehicle inspection. Generally, such prior inspection system at least includes a radiation source and a matching collimator for collimating rays from the radiation source into a sector-shape beam. The prior inspection system further includes several sensors for detecting the position of the object moving in a certain direction. An array of sensors are arranged opposite to the radiation source and receive the radiation rays passing through the moving object to form a digital image by which a dangerous object may be found.

However, such system can only perform inspection on a moving object running in a single specific direction and cannot perform inspection on moving objects running in other directions. For application situations where the ground traffic network is complicated or there is a limited occupation space for the system, such system cannot be used. As the result, the inspection efficiency is low and the costs of apparatus and labor are increased.

### SUMMARY OF THE INVENTION

In the present invention, a system for radiation inspection on a moving object and a method for radiation inspection on a moving object are provided, and they enable radiation inspection on the moving objects running in multiple directions and enable a high working efficiency.

In the present invention, a system for radiation inspection on a moving object is provided, and it comprises: a radiation source and a radiation detector, with the radiation source emitting rays and the radiation detector collecting rays for radiation imaging, wherein the radiation source and the radiation detector are located on either side of a detection passage, respectively, and the radiation source emits the rays which are restricted within a scanning region having a first boundary plane and a second boundary plane; and the system further comprises: a plurality of detecting units arranged in sequence along a detection passage, being triggered and sending a signal when detecting that the moving object arrives or leaves; and a control module used for receiving the signal sent by the plurality of detecting units, and controlling the radiation source based on the received signal to perform radiation inspection on the moving object; wherein a first, second, and third detecting units of the plurality of detecting units are located at one side of the scanning region, and near the first boundary plane; the fourth, fifth, and sixth detecting units of the plurality of detecting units are located at the other side of the scanning region, and near the second boundary plane; wherein the first, second, and third detecting units of the plurality of detecting units have respective distances L1, L2, L3 to the first boundary plane, wherein L1>L2>L3; a fourth, fifth, and sixth detecting units of the plurality of detecting units have respective distances L4, L5, L6 to the second boundary plane, wherein L4<L5<L6; and each of L2 and L5 is not less than a length of a portion of the moving object which needs to be shielded from radiation.

Preferably, each of L3 and L4 has a value range of [0.1, 1], in meters.

Preferably, each of L2 and L5 has a value range of [1, 3], in meters.

Preferably, the control module is further used for comparing a moving speed of the moving object with a preset threshold, and terminating the radiation inspection process when the moving speed is less than the preset threshold.

Preferably, each of the second and fifth detecting units comprises at least two detecting sub-units which are arranged along the detection passage and spaced apart from one another.

Preferably, the detection passage has one or more inlets and has one or more outlets.

Preferably, in the position of the inlet of the detection passage, a traffic light and/or a movable bar are/is installed.

Preferably, in the position of the outlet of the detection passage, a traffic light and/or a movable bar are/is installed.

Preferably, in the step\textcircled{2}, after the control module receives the signal, the control module records a time point T1 at which the fourth or third detecting unit of the plurality of detecting units is triggered; the control module records a time point T2 at which the fifth or second detecting unit of the plurality of detecting units is triggered; and the control module calculates a moving speed of the moving object, wherein the speed value V=(L2−L3)/(T2−T1) or V=(L5−L4)/(T2−T1); when V is less than a preset threshold, the radiation inspection process is terminated; otherwise, after the fifth or second detecting unit of the plurality of detecting units detects that the moving object arrives, the radiation source is controlled to start emitting rays.

Preferably, when a time interval between time points at which any two adjacent detecting units of the plurality of detecting units are triggered, respectively, is larger than a preset time interval, the control module terminates the radiation inspection process.

Preferably, when the system comprises a traffic light and a movable bar, after the first or sixth detecting unit of the plurality of detecting units detects that the moving object enters the detection passage, the control module controls all the traffic lights to turn red and controls the movable bar at the inlet to be closed; after the sixth or first detecting unit of the plurality of detecting units detects that the moving object leaves the detection passage, the control module controls all the traffic lights and the movable bar to return to their ready states.

Preferably, when the system is in the ready state, all the traffic lights are green and all the movable bars are kept open.

Preferably, when the system is in the ready state, all the traffic lights are red and all the movable bars are kept closed; when the first or sixth detecting unit of the plurality of detecting units detects that the moving object arrives, the control module controls all the traffic lights to turn green and controls all the movable bars to be opened.

Preferably, when the system is in the ready state, all the traffic lights are red and all the movable bars are kept closed; when the first and sixth detecting units of the plurality of detecting units simultaneously detect that the moving object arrives, as a priority, the control modules controls the traffic light at the inlet where the first detecting unit inlet is located, to turn green and controls the movable bar to be opened.

Preferably, when the system is in the ready state, the traffic light at the inlet where the first detecting unit is located, is green and the movable bar is kept open; meanwhile, the traffic light at the inlet where the sixth detecting unit is located, is red and the movable bar is kept closed.

In another aspect, in the present invention, a system for radiation inspection on a moving object is further provided, and it comprises: a radiation source and a radiation detector, with the radiation source emitting rays and the radiation detector collecting rays for radiation imaging, wherein the radiation source and the radiation detector are located on either side of a detection passage, respectively, the radiation source emits rays which are restricted within a scanning region having a first boundary plane and a second boundary plane; and the system further comprises: a plurality of detecting units arranged in sequence along a detection passage, being triggered and sending a signal when detecting that the moving object arrives or leaves; and a control module used for receiving the signal sent by the plurality of detecting units, and controlling the radiation source based on the received signal to perform radiation inspection on the moving object; wherein the first and second detecting units of the plurality of detecting units are located at one side of the scanning region, and near the first boundary plane; the third and fourth detecting units of the plurality of detecting units are located at the other side of the scanning region, and near the second boundary plane; wherein the first and second detecting units of the plurality of detecting units have respective distances K1 and K2 to the first boundary plane, wherein K1>K2; the third and fourth detecting units of the plurality of detecting units have respective distances K3 and K4 to the second boundary plane, wherein K3<K4; and each of K2 and K3 is not less than a length of a portion of the moving object which needs to be shielded from radiation.

In another aspect, in the present invention, a method for radiation inspection on a moving object is further provided, and it comprises: step\textcircled{1}: the first or fourth detecting unit of the plurality of detecting units, when detecting that the moving object arrives, sending a signal to the control module; step\textcircled{2}: the control module, after receiving the signal and after the third or second detecting unit of the plurality of detecting units detects that the moving object arrives, controlling the radiation source to start emitting rays; step\textcircled{3}: after the third or second detecting unit of the plurality of detecting units detects that the moving object leaves, the control module controlling the radiation source to stop emitting rays.

### DESCRIPTION OF THE DRAWINGS

FIG. 1 is a schematic structural diagram of a system for radiation inspection according to an embodiment of the present invention.

FIG. 2 is a flow chart of a method for radiation inspection according to the embodiment of FIG. 1.

FIG. 3 is a flow chart of another method for radiation inspection according to the embodiment of FIG. 1.

FIG. 4 is a schematic diagram illustrating the shifting of working states of the radiation inspection according to the embodiment of FIG. 1.

FIG. 5 is a schematic structural diagram of a system for radiation inspection according to an embodiment of the present invention.

FIG. 6 is a flow chart of a method for radiation inspection according to the embodiment of FIG. 5.

FIGS. 7 and 8 are schematic structural diagrams of systems for radiation inspection according to embodiments of the present invention.

### DESCRIPTION OF EXEMPLARY EMBODIMENTS

Hereinafter, the technical solutions of the present invention will be described in detail in connection with specific embodiments and with reference to the accompanying drawings.

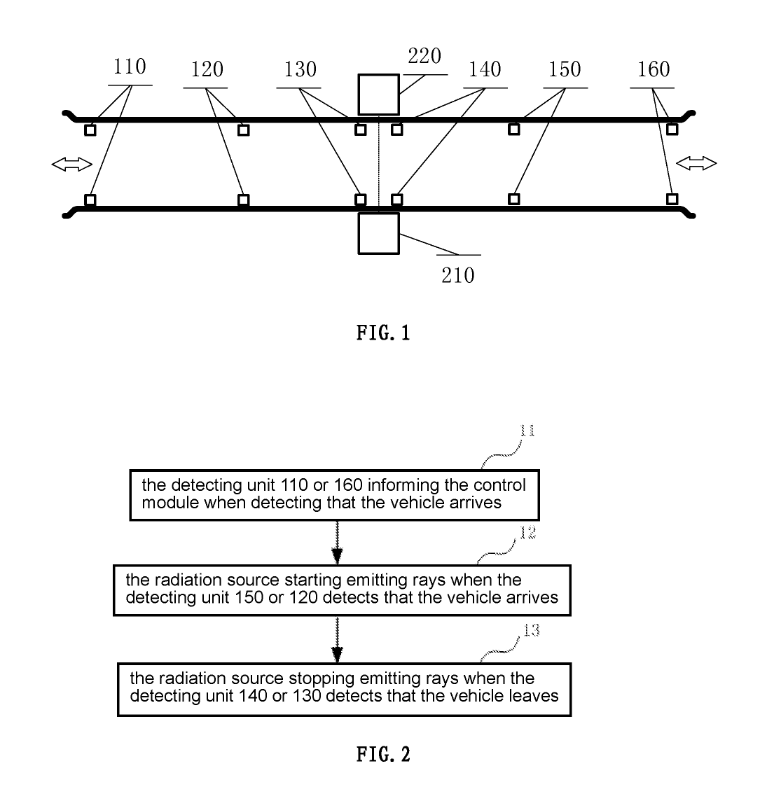

FIG. 1 is a schematic structural diagram of a system for radiation inspection according to an embodiment of the present invention, wherein a ray source 210 and an array type detector 220 for rays are located on either side of a detection passage, respectively. When a moving object (such as a vehicle) is passing by, the ray source 210 emits scanning rays, the detector 220 receives the ray(s) having passed through the object and converts the ray(s) into respective digital values, an imaging system (not shown in the Figure) processes the digital values and can then form a digital radiation image, thereby completing the radiation scanning security check process. During scanning, the rays from the radiation source are collimated by a collimator and are restricted within a scanning region. Any object beyond the scanning region will not be irradiated by the rays. Regarding the scanning region, it refers to a spatial region occupied by emitting rays from the radiation source 210. In order to prevent radiation to any person by accident, the range of the scanning region may be adjusted according to practical requirements.

In the embodiment of FIG. 1, the detecting units 110, 120, 130, 140, 150, 160 arranged in sequence along the scanning detection passage are the detecting units having different distances from the ray source, for detecting arrival or leaving of the moving object. These detecting units may be a photoelectric switch, a light screen, a ground sense coil, an axle load sensor, etc., or may be a combination of these sensors. These detecting units may be arranged above the ground of the scanning passage, or may be arranged below the ground of the scanning passage.

In the embodiment, the detecting units 110 and 160 are located at two ends of the detection passage, respectively. They may detect whether a moving object (such as a vehicle) is coming, whether the moving object has been completely in the detection passage, whether the moving object has exited the detection passage. As shown in FIG. 1, if the vehicle enters the passage from the left end, the left end is the inlet and the right end is the outlet; otherwise, if the vehicle enters from the right end, the right end is the inlet and the left end is the outlet.

In the embodiment, the detecting units 120 and 150 are located in the scanning passage, on either side of the scanning region, respectively, and are each spaced apart from the scanning region by a distance that depends on the length of a portion of the moving object which needs to be shielded from radiation. For example, for a vehicle, the portion which needs to be shielded from radiation is the driving cab in which the driver is seated, and the distance of each of the detecting units 120 and 150 to a boundary of the scanning region should be not less than the length of the portion of the driving cab.

In the embodiment, it is configured such that the detecting units 120 and 150 are spaced apart from the scanning region by certain distances. That is, it is configured such that the detecting unit 120 is spaced apart from the left boundary (i.e. a vertical plane perpendicular to the paper plane in fact) of the scanning region by a certain distance and the detecting unit 150 is spaced apart from the right boundary of the scanning region by a certain distance, and specifically a distance of 1˜3 meters would be appropriate. The distance from the detecting unit 120 to the left boundary of the scanning region and the distance from the detecting unit 150 to the right boundary of the scanning region may be the same or may be different.

In some embodiment(s) of the present invention, the detecting unit 120 or 150 comprises several sensors arranged along the passage and spaced apart from one another. Each sensor may be independently considered as the detecting unit 120 or 150 for use, for the purpose of detecting and determining the portion which needs to be shielded from radiation, in various types of moving objects, and avoiding exposure of said portion under radiation. For example, for radiation inspection on various types of vehicles, it is necessary to avoid the driving cab in which the driver is seated. The arranged several sensors are spaced apart from one another by a distance, and thus can detect not only the driving cab of the type of truck vehicles having relatively large volume, but also the driving cab of the type of cars having relatively small volume, thereby enabling 100% radiation avoidance for the driving cab and the driver therein.

In some embodiment(s) of the present invention, the detecting units 130 and 140 are located on either side of the scanning region, respectively, in positions near the scanning region. For example, the detecting unit 130 is spaced apart from the left boundary of the scanning region by a distance of 0.1˜1 meter, and the detecting unit 140 is spaced apart from the right boundary of the scanning region by a distance of 0.1˜1 meter. These two distances may be the same or may be different. The detecting units 130 and 140 can detect whether the moving object has left the scanning region, and inform the control system to immediately stop ray emitting from the ray source, thereby reducing unnecessary ray irradiation.

In some embodiment(s) of the present invention, in positions near the detecting units 110 and 160, a bar and a traffic light (not shown in FIG. 1) may be arranged to restrict running of the moving object and to prevent irrelevant moving object from entering the scanning passage.

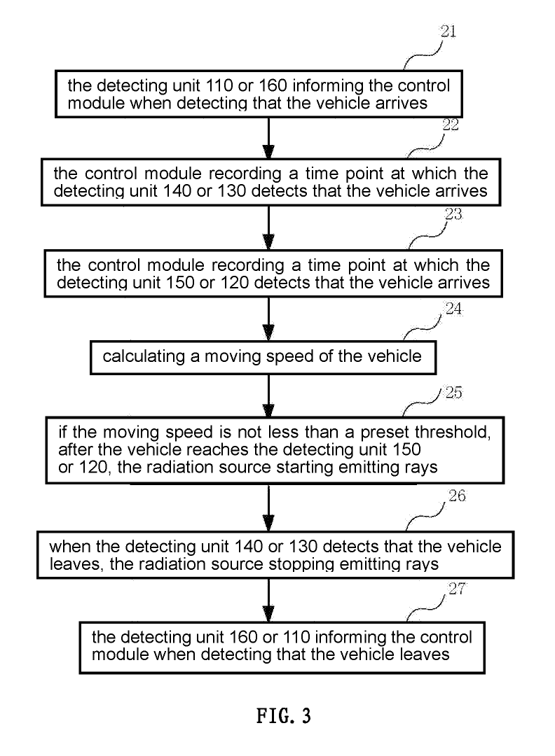

FIG. 2 is a flow chart of a method for radiation inspection on a moving object according to an embodiment of the present invention. Referring to FIG. 1, in inspection, the vehicle may enter the passage from the left, or may enter the passage from the right. When the automatic inspection system is in a “ready” state, the bars in the positions where the detecting units 110 and 160 are located, are in an open state and the traffic lights are green. Taking a case in which the vehicle enters the scanning passage from the left, as an example, the vehicle first reaches the detecting unit 110 and triggers the detecting unit 110, and then the traffic lights in the positions of the detecting units 110 and 160 are turned red; when the detecting unit 110 detects that the vehicle has completely enters the scanning passage, the bar in the position of the detecting unit 110 is put down to prevent any subsequent vehicle from entering by accident; then the vehicle reaches the detecting units 120, 130, 140 in sequence (at this moment, the radiation source does not emit rays), and when the vehicle reaches the detecting unit 150, it can be determined that the vehicle driving cab portion which needs avoidance has passed the scanning region and the vehicle carriage portion to be inspected has entered the scanning region; at this moment, the control system, after receiving the signal indicating the triggering of the detecting unit 150, controls the ray source to emit rays to scan the vehicle carriage for inspection; in this process, the vehicle continues running forward, and when the tail of the vehicle leaves the scanning region, the detecting unit 140 detects that the vehicle leaves the scanning region; the control system, after receiving the signal from the detecting unit 140, immediately controls the ray source to stop emitting rays, thereby reducing unnecessary ray irradiation; then the vehicle leaves the detecting units 150 and 160 in sequence; when the detecting unit 160 detects that the vehicle has left, the control system, according to the signal from the detecting unit 160, switches the inspection system to the ready state, turns the traffic lights at the two ends of the passage green and opens all the bars at the two ends.

During radiation scanning to the moving object, if the moving speed of the object is too low, it is inappropriate to activate radiation scanning. For this reason, during automatic inspection of the present invention, a vehicle speed detecting mechanism may be further provided. Referring to FIG. 3, also taking the case in which the vehicle enters the detection passage from the left, as an example, after the detecting unit 110 is triggered by the vehicle, the control system also records the time points at which the vehicle reaches the detecting units 140 and 150. As the distance between the detecting units 140 and 150 is known, according to this distance and a difference between time points at which the vehicle reaches the detecting units 140 and 150, the speed of the vehicle carriage (excluding the driving cab portion) at which it passes through the scanning region thus can be calculated. When the control system detects the speed of the moving object, it judges, based on this speed, whether to control the ray source to emit rays for scanning the moving object. If the speed of the moving object is too low, such as lower than 3 km/h, it is difficult to avoid radiation to persons and the radiation scanning should not be performed in this case. The process should be terminated and other manners may be selected to complete the security check. Otherwise, if the speed of the moving object is sufficiently high, such as not less than 3 km/h, the ray source may be activated for scanning inspection. In different application situations, it is possible to set vehicle speed thresholds suitable for activating radiation scanning according to practical requirements.

In some embodiment(s) of the present invention, the imaging system may, according to the vehicle speed detected by the control system, perform image correction in the running direction of the vehicle to the obtained scanning image, thereby reducing image deformation that is caused due to the change in vehicle speed.

Hereinafter, the case(s) in which the vehicle enters the scanning passage from the right in FIG. 1 will be described. When 160 detects that the vehicle arrives, the traffic lights in the positions of the detecting units 110 and 160 are turned red; when 160 detects that the vehicle leaves, the bar in the position of the detecting unit 160 is put down to prevent any subsequent vehicle from entering by accident; the vehicle reaches the detecting units 150, 140, 130 in sequence, and when the vehicle reaches the detecting unit 150, it can be determined that the vehicle head which needs avoidance has passed the scanning region and the vehicle carriage to be inspected has entered the scanning region; the control system, after receiving the signal from the detecting unit 120, based on the time points at which the vehicle reaches the detecting units 120 and 130, calculates the running speed, and if the speed meets the requirement(s), it controls the ray source to emit rays to scan the vehicle carriage for inspection; the vehicle continues to run forward, and when the vehicle leaves the scanning region, the detecting unit 130 detects that the vehicle leaves its position; the control system, after receiving the signal from 130, controls the ray source to stop emitting rays, thereby reducing unnecessary ray irradiation; the vehicle leaves the detecting units 120 and 110 in sequence; when the detecting unit 110 detects that the vehicle leaves its position, the control system, according to the signal from the detecting unit 110, switches the inspection system to the ready state, turns the traffic lights at the two ends of the passage green and opens the bars at the two ends.

FIG. 4 is a schematic diagram illustrating the shifting of working states of the radiation inspection based on the embodiment of FIG. 1. It can be seen that after the radiation inspection system is in the ready state, only when the respective sensors are triggered in sequence according to the specific order and the moving speed of the object meets the requirement, can the ray source be activated, thereby ensuring that the system can properly avoid the portion which needs avoidance and activate the scanning inspection on the portion which needs inspection.

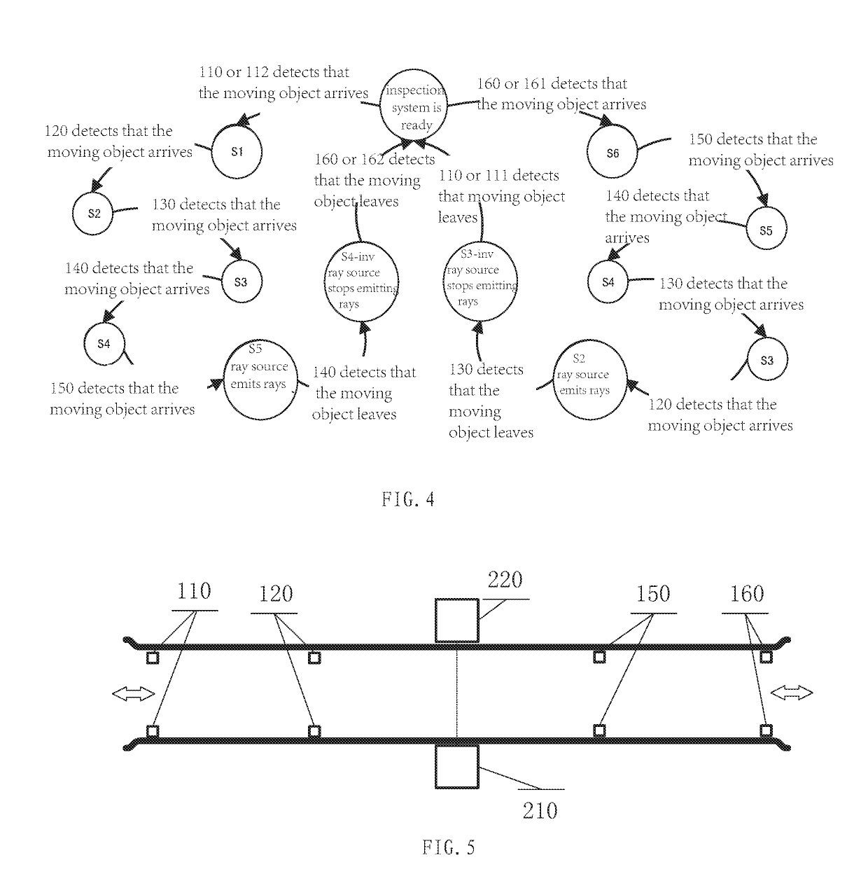

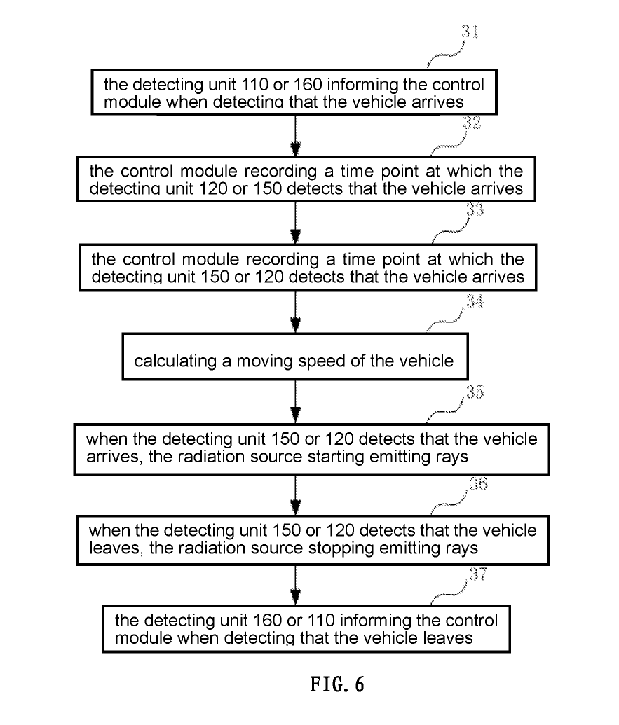

FIG. 5 is a structural diagram of a system for radiation inspection according to an embodiment of the present invention. The embodiment of FIG. 5 differs from the embodiment of FIG. 1 in that in the embodiment of FIG. 5, the detecting units 130 and 140 used in the embodiment of FIG. 1 are omitted, and as an alternative, the detection previously performed by the detecting unit 130 is performed by the detecting unit 120 and the detection previously performed by the detecting unit 140 is performed by the detecting unit 150, thereby providing signals needed in the scanning inspection process to the control system. FIG. 6 is a flow chart for performing a scanning task by the system for radiation inspection according to the embodiment of FIG. 5.

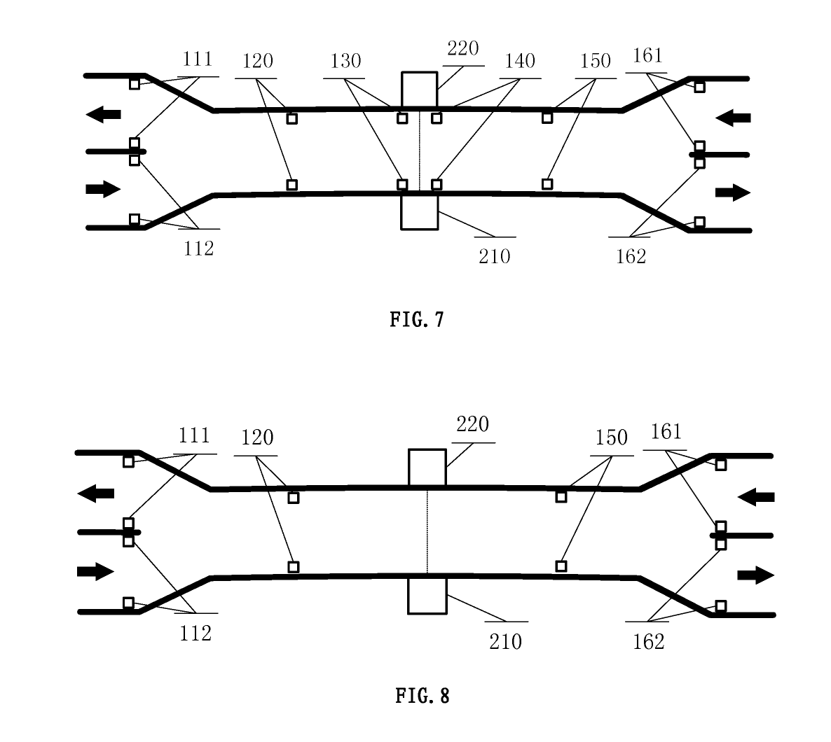

In some embodiment(s) of the present invention, in order to handle the complicated situations of the ground traffic network, the automatic inspection system may be attached to several roads in different directions in the ground traffic. FIG. 7 shows a situation where at each end of the inspection passage, there are two roads. Compared with the embodiment of FIG. 1, in the embodiment of FIG. 7, the vehicles running in different directions are separated such that the entering and exiting vehicles do not share the same inlet or outlet any more. Instead, a vehicle enters the inspection passage via a specific inlet and then leaves via a specific outlet, thereby facilitating scheduling and controlling the vehicles under inspection running in different directions. In the same way, the inspection system in the embodiment of FIG. 5 may be attached to the road in a manner as shown in FIG. 8.

In the embodiments of FIG. 7 and FIG. 8, with more inlets and outlets, there will be more detecting units at the inlets and the outlets accordingly, wherein the previous detecting unit 110 is replaced by the detecting units 111 and 112, the previous detecting unit 160 is replaced by the detecting units 161 and 162, and the configuration of other detecting units is unchanged. In addition, as to the configuration of the bars and the traffic lights, they may be disposed at all inlets and outlets, or the bars and the traffic lights may be disposed only at the inlets where the detecting units 112 and 161 are located.

In some embodiment(s) of the present invention, the control system may set a maximum time difference between time points at which adjacent detecting units are triggered in sequence, such as 15 s. If the difference between time points of two adjacent detecting units being triggered is larger than the set value, the control system stops the inspection process and re-switches the inspection system to the ready state, so as to prevent the inspection system from being in the activated state for a long time due to accidental triggering of the detecting unit(s) or due to other faults.

In the embodiments of FIG. 7 and FIG. 8, radiation inspection can be carried out on the vehicle no matter which direction the vehicle is running in. For example, in a direction, the moving object enters from the detecting unit 112 and then leaves from the detecting unit 162; while in another direction, the moving object enters from the detecting unit 161 and then leaves from the detecting unit 111. The inspection system is generally arranged in a compact manner and occupies a relatively small space.

In the radiation inspection, when the automatic inspection system is in the ready state, the bars at the positions of the detecting units 112 and 161 are open and the traffic lights at the positions of the detecting units 112 and 161 are green. When 112 detects that the vehicle arrives, the traffic lights at the positions of the detecting units 112 and 161 are turned red and the bar at the position of the detecting unit 161 is put down; when 112 detects that the vehicle leaves, the bar at the position of the detecting unit 112 is put down to prevent any subsequent vehicle from entering by accident; the vehicle reaches 120, 130, 140 in sequence and when the vehicle reaches the detecting unit 150, it can be determined that the vehicle head which needs avoidance has passed the scanning region and the vehicle carriage portion to be inspected has entered the scanning region; provided that the vehicle running speed is larger than the preset value, the ray source is controlled to immediately emit rays to scan the vehicle carriage for inspection; the vehicle continues to run forward, and when the vehicle leaves the scanning region, the detecting unit 140 detects that the vehicle leaves its position; the control system, after receiving the signal from 140, immediately controls the ray source to stop emitting rays, thereby reducing unnecessary ray irradiation; the vehicle leaves the detecting units 150 and 162 in sequence; when the detecting unit 162 detects that the vehicle leaves, the control system, according to the signal from 162, switches the inspection system to the ready state, turns the traffic lights at the two ends of the passage green and opens all the bars at the two ends.

In the same way, when the detecting unit 161 detects that the vehicle arrives, the traffic lights at the positions of the detecting units 112 and 161 are turned red and the bar at the position of 112 is put down; when the detecting unit 161 detects that the vehicle leaves, the bar at the position of the detecting unit 161 is put down to prevent any subsequent vehicle from entering by accident; the vehicle reaches 150, 140, 130 in sequence, when the vehicle reaches 120, it can be determined that the vehicle head which needs avoidance has passed the scanning region and the vehicle carriage to be inspected enters the scanning region; provided that the vehicle running speed is larger than the preset value, the ray source is controlled to immediately emit rays to scan the vehicle carriage for inspection; the vehicle continues to run forward, and when the vehicle leaves the scanning region, the detecting unit 130 detects that the vehicle leaves its position; the control system, after receiving the signal from the detecting unit 130, immediately controls the ray source to stop emitting rays, thereby reducing unnecessary ray irradiation; the vehicle leaves the detecting units 120 and 111 in sequence; when the detecting unit 111 detects that the vehicle leaves, the control system, according to the signal from the detecting unit 111, switches the inspection system to the ready state, turns the traffic lights at the two ends of the passage green and opens all the bars at the two ends.

In some embodiment(s) of the present invention, when the automatic inspection system is in the ready state, all the bars are put down. Only when the detecting units 110, 112, 160, 161 detect that the moving object arrives, can the bar corresponding to the running direction of the moving object be opened.

In some embodiment(s) of the present invention, in radiation inspection, when the automatic inspection system is in the ready state, the bars at the positions of the detecting units 112 and 161 are put down and the traffic lights at the positions of the detecting units 112 and 161 are red. When the detecting units detect that the moving object arrives, the control system or an operation person, according to the traffic flow condition in the two running directions, selectively opens a bar in one of the two running directions, allowing the object moving in that running direction to enter for scanning inspection. When the object moving in that running direction leaves the inspection system, the control system or an operation person, according to the traffic flow condition in the two directions, selectively opens a bar in one of the two running directions, allowing a next moving object to enter for scanning inspection.

In some embodiment(s) of the present invention, a priority inspection mechanism may be configured for the inspection system. When the inspection system is in the ready state, the bar of the passage in one running direction is configured to keep open (with the traffic light being green), while bar of the passage in another running direction is configured to keep closed (with the traffic light being red). Therefore, when there are vehicles in both directions waiting for inspection, as a priority, the vehicle on the side where the bar is open may first enters the inspection passage for scanning inspection. For example, the direction from left to right in FIG. 5 may be selected as the priority inspection direction. Therefore, when the system is ready, the bar at the position of the detecting unit 112 is open while the bar at the position of the detecting unit 161 is in the closed state; also, the traffic light at the position of the detecting unit 112 is green while the traffic light at the position of the detecting unit 161 is red. When there are vehicles coming in both directions, the vehicle on the side of the detecting unit 112 may directly enter the inspection passage while the vehicle on the side of the detecting unit 161 cannot enter. When the vehicle enters the scanning passage from the side of the detecting unit 112, the traffic light in the position where the detecting unit 112 is located is turned red, and when the vehicle leaves the position of the detecting unit 112, the bar in the position where the detecting unit 112 is located, is put down. After the vehicle leaves the position of the detecting unit 162 after the scanning inspection, the system is recovered to the previous ready state. Thereafter, if the detecting unit 161 detects that a vehicle arrives, the bar at the detecting unit 161 is opened and the traffic light is turned green; at the same time, the bar at the detecting unit 112 is closed and the traffic light is turned red; the vehicle enters from the side of the detecting unit 161. In addition, in a similar process, the direction from right to left may be configured as the priority entering direction for inspection.

In the embodiment(s) of the present invention, the plurality of detecting units are reasonably arranged, and the radiation controlling process during inspection on the moving object(s) is designed accordingly. With the embodiment(s) of the present invention, the moving objects coming from different directions in the ground traffic network may be scanned for inspection, thereby enabling a high efficiency of security check, effectively avoiding the portion(s) that needs to be shielded from radiation during inspection, preventing the object running with a relatively low speed from being put under radiation scanning and thus ensuring personnel safety.

Hereinbefore, the technical solutions of the present invention are described in detail in connection with specific embodiments. The specific embodiments as described are used to facilitate understanding of the concept of the present invention. Any derivation or variation made by those skilled in the art based on the specific embodiments of the present invention will fall into the protection scope of the present invention.

1. A system for radiation inspection on a moving object, comprising: a radiation source and a radiation detector, with the radiation source emitting rays and the radiation detector collecting rays for radiation imaging, wherein,
the radiation source emits the rays which are restricted within a scanning region having a first boundary plane and a second boundary plane; and the system further comprises:
a plurality of detecting units arranged in sequence along a detection passage, for sending a signal when detecting that the moving object arrives or leaves; and
a control module used for receiving the signal sent by the plurality of detecting units, and controlling the radiation source based on the received signal to perform radiation inspection on the moving object; wherein
a first, second, and third detecting units of the plurality of detecting units are located at one side of the scanning region, and near the first boundary plane;
a fourth, fifth, and sixth detecting units of the plurality of detecting units are located at the other side of the scanning region, and near the second boundary plane; wherein,
the first, second, and third detecting units of the plurality of detecting units have respective distances L1, L2, L3 to the first boundary plane, wherein L1>L2>L3;
the fourth, fifth, and sixth detecting units of the plurality of detecting units have respective distances L4, L5, L6 to the second boundary plane, wherein L4<L5<L6; and
each of L2 and L5 is not less than a length of a portion of the moving object which needs to be shielded from radiation.

2. The system for radiation inspection on the moving object according to claim 1, wherein each of L3 and L4 has a value range of [0.1, 1], in meters.

3. The system for radiation inspection on the moving object according to claim 1, wherein each of L2 and L5 has a value range of [1, 3], in meters.

4. The system for radiation inspection on the moving object according to claim 1, wherein the control module is further used for comparing a moving speed of the moving object with a preset threshold, and terminating the radiation inspection process when the moving speed is less than the preset threshold.

5. The system for radiation inspection on the moving object according to claim 4, wherein the preset threshold is 3 km/hour.

6. The system for radiation inspection on the moving object according to claim 1, wherein each of the second and fifth detecting units comprises at least two detecting sub-units which are arranged along the detection passage and spaced apart from one another.

7. The system for radiation inspection on the moving object according to claim 1, wherein the detection passage has one or more inlets and has one or more outlets.

8. The system for radiation inspection on the moving object according to claim 7, wherein in the position of the inlet of the detection passage, a traffic light and/or a movable bar are/is installed.

9. The system for radiation inspection on the moving object according to claim 7, wherein in the position of the outlet of the detection passage, a traffic light and/or a movable bar are/is installed.

10. A method for radiation inspection on a moving object, based on the system according to claim 1, wherein the method comprises:
step\textcircled{1}: the first or sixth detecting unit of the plurality of detecting units, when detecting that the moving object arrives, sending a signal to the control module;
step\textcircled{2}: the control module, after receiving the signal and the fifth or second detecting unit of the plurality of detecting units detecting that the moving object arrives, controlling the radiation source to start emitting rays;
step\textcircled{3}: after the fourth or third detecting unit of the plurality of detecting units detects that the moving object leaves, controlling the radiation source to stop emitting rays.

11. The method according to claim 10, wherein in the step\textcircled{2}, after the control module receives the signal, the method further comprises:
the control module recording a time point T1 at which the fourth or third detecting unit of the plurality of detecting units is triggered;
the control module recording a time point T2 at which the fifth or second detecting unit of the plurality of detecting units is triggered;
the control module calculating a moving speed of the moving object, wherein the speed value V=(L2−L3)/(T2−T1) or V=(L5−L4)/(T2−T1); and
when V is less than a preset threshold, terminating the radiation inspection process; otherwise, after the fifth or second detecting unit of the plurality of detecting units detects that the moving object arrives, controlling the radiation source to start emitting rays.

12. The method according to claim 10, wherein the method further comprises:
when a time interval between time points at which any two adjacent detecting units of the plurality of detecting units are triggered, respectively, is larger than a preset time interval, the control module terminating the radiation inspection process.

13. The method according to claim 12, wherein the preset time interval is 15 seconds.

14. The method according to claim 10, wherein when both a traffic light and a movable bar are installed in the positions of the inlet and the outlet of the detection passage, the method further comprises:
after the first or sixth detecting unit detects that the moving object enters the detection passage, turning all the traffic lights red and closing the movable bar at the inlet;
after the sixth or first detecting unit detects that the moving object leaves the detection passage, all the traffic lights and the movable bar returning to their ready states.

15. The method according to claim 14, wherein when the system is in the ready state, all the traffic lights are green and all the movable bars are kept open.

16. The method according to claim 14, wherein when the system is in the ready state, all the traffic lights are red and all the movable bars are kept closed;
when the first or sixth detecting unit detects that the moving object is to enter the detection passage, all the traffic lights are turned green and all the movable bars are opened.

17. The method according to claim 14, wherein when the system is in the ready state, all the traffic lights are red and all the movable bars are kept closed;
when the first and sixth detecting units detect simultaneously that the moving object is to enter the detection passage, as a priority, a traffic light near the first detecting unit is made green and a movable bar near the first detecting unit is made open.

18. The method according to claim 14, wherein when the system is in the ready state, a traffic light near the first detecting unit is green and the movable bar is kept open, meanwhile, a traffic light near the sixth detecting unit is red and the movable bar is kept closed.

19. A system for radiation inspection on a moving object, comprising: a radiation source and a radiation detector, with the radiation source emitting rays and the radiation detector collecting rays for radiation imaging, wherein,
the radiation source emits rays which are restricted within a scanning region having a first boundary plane and a second boundary plane; and the system further comprises:
a plurality of detecting units arranged in sequence along a detection passage, for sending a signal when detecting that the moving object arrives or leaves; and
a control module used for receiving the signal sent by the plurality of detecting units, and controlling the radiation source based on the received signal to perform radiation inspection on the moving object; wherein,
the first and second detecting units of the plurality of detecting units are located at one side of the scanning region, and near the first boundary plane;
the third and fourth detecting units of the plurality of detecting units are located at the other side of the scanning region, and near the second boundary plane; wherein
the first and second detecting units of the plurality of detecting units have respective distances K1 and K2 to the first boundary plane, wherein K1>K2;
the third and fourth detecting units of the plurality of detecting units have respective distances K3 and K4 to the second boundary plane, wherein K3<K4; and
each of K2 and K3 is not less than a length of a portion of the moving object which needs to be shielded from radiation.

20. The system for radiation inspection on the moving object according to claim 19, wherein each of K2 and K3 has a value range of [1, 3], in meters.

21-23. (canceled)
